(19) United States
(12) Patent Application Publication
(10) Pub. No.: US 2022/0286867 A1
(43) Pub. Date: Sep. 8, 2022

(54) NETWORK NODE, USER EQUIPMENT AND METHODS PERFORMED THEREIN

(71) Applicant: Telefonaktiebolaget LM Ericsson (publ), Stockholm (SE)

(72) Inventors: Iana SIOMINA, TÄBY (SE); Ritesh SHREEVASTAV, UPPLANDS VÄSBY (SE)

(21) Appl. No.: 17/626,485

(22) PCT Filed: Jul. 2, 2021
(86) PCT No.: PCT/SE2020/050704

§ 371 Date: Jan. 11, 2022

Related U.S. Application Data
(60) Provisional application No. 62/873,201, filed on Jul. 12, 2019.

(51) Int. Cl. H04W 16/28; H04B 7/08; H04B 7/06

(52) U.S. Cl. CPC H04W 16/28; H04B 7/088; H04B 7/0695; H04B 7/0617

(57) ABSTRACT

The present disclosure presents a network node, a wireless device such as a user equipment (UE), and methods performed therein for communication. Furthermore, a computer program product and a computer readable storage medium are also disclosed herein. In particular, embodiments herein relate to enabling or handling communication of the UE in a wireless communication network. In one example embodiment, a method is performed by a wireless device. A reference direction is determined. Furthermore, one or more preferred directions is/are obtained. Still further, one or more directional transmissions and/or receptions based on the obtained preferred direction(s) with respect to the determined reference direction is/are performed.

### TECHNICAL FIELD

Embodiments herein relate to a network node, a wireless device such as a user equipment (UE), and methods performed therein for communication. Furthermore, a computer program product and a computer readable storage medium are also provided herein. In particular, embodiments herein relate to enabling or handling communication of the UE in a wireless communication network.

### BACKGROUND

This section is intended to provide a background to the various embodiments of the technology that are described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by its mere inclusion in this section.

In a typical wireless communication network, user equipments (UE), also known as wireless communication devices, mobile stations, stations (STA) and/or wireless device, communicate via a Radio Access Network (RAN) to one or more core networks (CN). The RAN covers a geographical area which is divided into service areas or cells, with each service area or cell being served by a radio network node such as a radio access node e.g., a W-Fi access point or a radio base station (RBS), which in some networks may also be denoted, for example, a “NodeB” (NB) or “eNodeB” (eNB), “gNodeB” (gNB). A service area or cell is a geographical area where radio coverage is provided by the radio network node. The radio network node communicates over an air interface operating on radio frequencies with the UE within range of the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for UEs. In a forum known as the Third Generation Partnership Project (3GPP), telecommunications suppliers propose and agree upon standards for third generation networks, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3^{rd} Generation Partnership Project (3GPP) and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface. EPS is the Evolved 3GPP Packet Switched Domain. New radio (NR) is a new radio access technology being standardized in 3GPP.

Embodiments herein are described within the context of 3GPP NR radio technology (3GPP TS 38.300 V15.2.0 (2018 June)). It is understood, that the embodiments herein are equally applicable to wireless access networks and UEs implementing other access technologies and standards. NR is used as an example technology in the embodiments herein, and using NR in the description therefore is particularly useful for understanding the problem and solutions solving the problem. In particular, the embodiments herein are applicable also to 3GPP LTE, or 3GPP LTE and NR integration, also denoted as non-standalone NR.

NR positioning.

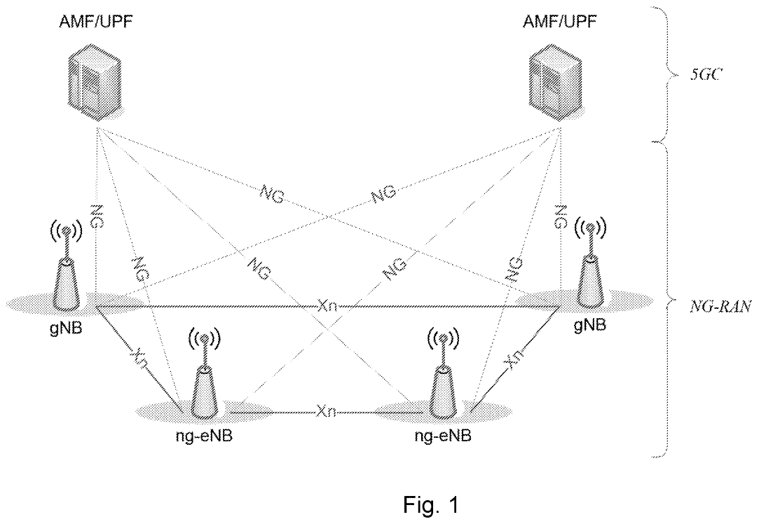

NR (a.k.a. 5G or Next Generation) architecture is being discussed in 3GPP and the current concept is illustrated in FIG. 1 (cf. 3GPP TS 38.300 V1.0.1 (2017 September)), where eNB denotes LTE eNodeB, gNB and ng-eNB (or evolved eNB) denote NR base stations (BS) (one NR BS may correspond to one or more transmission/reception points), and the lines between the nodes illustrate the corresponding interfaces which are under discussion in 3GPP.

Multi-Antenna Schemes in NR.

Using multi-antenna schemes for NR is an important feature. For NR, frequency ranges up to 100 GHz are considered. Currently, two NR frequency ranges are explicitly distinguished in 3GPP: frequency range FR1 (below 6 GHz) and frequency range FR2 (above 24 GHz). It is known that high-frequency radio communication above 24 GHz suffers from significant path loss and penetration loss. One solution to address this issue is to deploy large-scale antenna arrays to achieve high beamforming gain, which is a reasonable solution due to the small wavelength of high-frequency signal. Therefore Multiple Input Multiple Output (MIMO) schemes for NR are also called massive MIMO. For around 30/70 GHz, up to 256 Tx and Rx antenna elements are assumed. Extension to support 1024 Tx at 70 GHz is agreed and it is under discussion for 30 GHz. For sub-6 GHz communication, to obtain more beamforming and multiplexing gain by increasing the number of antenna elements is also a trend.

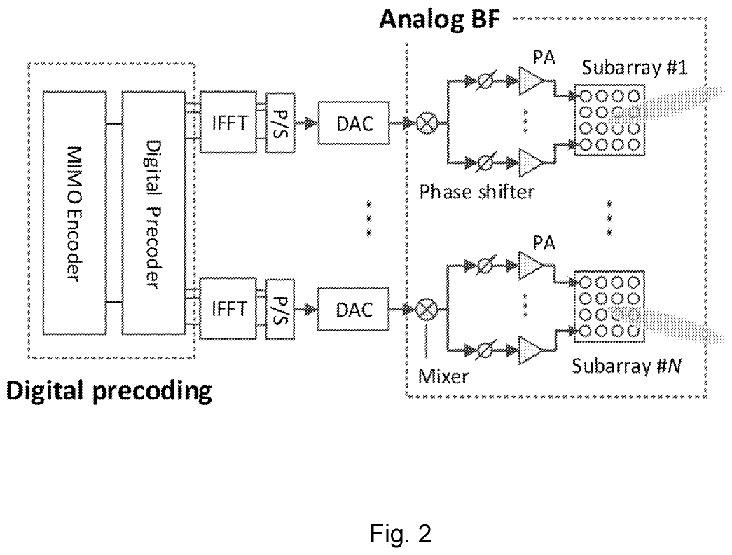

With massive MIMO, three approaches to beamforming have been discussed: analog, digital, and hybrid (a combination of the two). The analog beamforming would compensate high pathloss in NR scenarios, while digital precoding would provide additional performance gains similar to MIMO for sub-6 GHz necessary to achieve a reasonable coverage. The implementation complexity of analog beamforming is significantly less than digital precoding since it is in many implementations relies on simple phase shifters, but the drawbacks are its limitation in multi-direction flexibility (i.e., a single beam can be formed at a time and the beams are then switched in time domain), only wideband transmissions (i.e., not possible to transmit over a subband), unavoidable inaccuracies in the analog domain, etc. Digital beamforming (requiring costly converters to/from the digital domain from/to intermediate frequency (IF) domain), used today in LTE, provides the best performance in terms of data rate and multiplexing capabilities (multiple beams over multiple subbands at a time can be formed), but at the same time it is challenging in terms of power consumption, integration, and cost; in addition to that the gains do not scale linearly with the number of transmit/receive units while the cost is growing rapidly. Supporting hybrid beamforming, to benefit from cost-efficient analog beamforming and high-capacity digital beamforming, is therefore desirable for NR. An example diagram for hybrid beamforming is shown in FIG. 2.

Beamforming can be on transmission beams and/or reception beams, network side or UE side.

Beam Sweeping

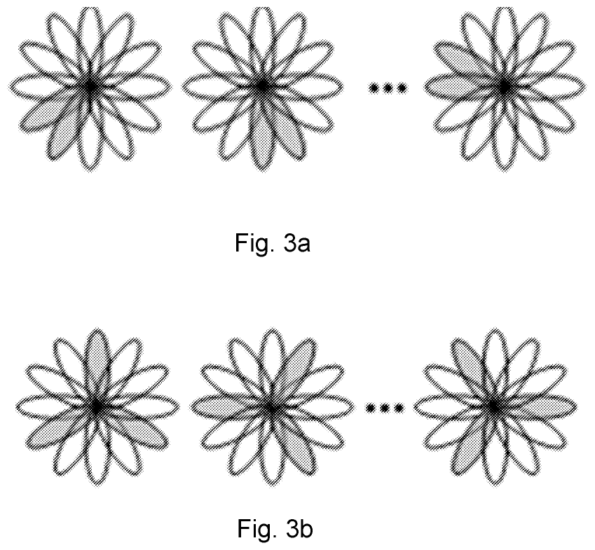

The analog beam of a subarray can be steered toward a single direction on each orthogonal frequency-division multiplexing (OFDM) symbol, and hence the number of subarrays determines the number of beam directions and the corresponding coverage on each OFDM symbol. However, the number of beams to cover the whole serving area is typically larger than the number of subarrays, especially when the individual beam-width is narrow. Therefore, to cover the whole serving area, multiple transmissions with narrow beams differently steered in time domain are also likely to be needed. The provision of multiple narrow coverage beams for this purpose has been called “beam sweeping”. For analog and hybrid beamforming, the beam sweeping seems to be essential to provide the basic coverage in NR. For this purpose, multiple OFDM symbols, in which differently steered beams can be transmitted through subarrays, can be assigned and periodically transmitted. With analog beam sweeping, only one beam is transmitted at a time, while with digital or hybrid multiple simultaneous beams are possible (see e.g. FIGS. 3a and 3b).

FIG. 3a shows a transmission (Tx) beam sweeping on 2 subarrays. FIG. 3b shows a Tx beam sweeping on 3 subarrays.

### SUMMARY

It is in view of the above that the various embodiments of the present disclosure have been made.

The present disclosure recognizes the fact that, in some cases, it is desirable that a UE is transmitting also in other directions within a specific range with respect to its serving cell direction, which is not possible to control right now (i.e., in the existing art prior to this disclosure). In some cases it is desirable to control the range of transmit and/or receive beam sweeping in the UE, which is not possible right now (i.e., in the existing art prior to this disclosure).

The present disclosure also recognizes the fact that, in some cases, for example for Uplink Positioning methods such as Multi-cell Round trip time (RTT) or Uplink Time Difference of Arrival (UTDOA), it is desirable that the UE is transmitting towards a distant neighbor base station. In FR2, as the range could be limited, it is desired that UE projects a more focused beam in the right direction so that a distant listening node can comprehend the signal with an acceptable signal strength

An object of embodiments herein is to provide a mechanism for improving, in an efficient manner, performance of the wireless communication network e.g. when positioning a UE in the wireless communication network.

This general object has been addressed by the appended independent claims. Advantageous embodiments are defined in the appended dependent claims.

According to an aspect the object is achieved by providing a method performed by a UE for handling communication in a wireless communication network. The UE determines a reference direction and obtains one or more preferred directions with respect to the reference direction. The UE performs one or more directional transmissions and/or receptions based on the preferred directions with respect to a reference direction.

According to another aspect the object is achieved by providing a method performed by a network node for handling communications from a UE in the wireless communication network. The network node determines a reference direction, e.g.

receives or configures the reference direction, and obtains one or more preferred directions with respect to the reference direction. The network node further performs one or more operations for one or more directional transmissions and/or receptions based on the preferred directions with respect to a reference direction.

According to yet another aspect the object is achieved by providing a network node and a UE configured to perform the methods herein.

It is furthermore provided herein a computer program product comprising instructions, which, when executed on at least one processor, cause the at least one processor to carry out any of the methods above, as performed by the UE or the network node, respectively. It is additionally provided herein a computer-readable storage medium, having stored thereon a computer program product comprising instructions which, when executed on at least one processor, cause the at least one processor to carry out the method according to any of the methods above, as performed by the UE or the network node, respectively.

According to still another aspect, a method performed by a wireless device (e.g., for positioning purposes) is provided. The method comprises: determining a reference direction; obtaining one or more preferred directions with respect to the reference direction; and performing one or more directional transmissions and/or receptions based on the obtained preferred direction(s) with respect to the determined reference direction.

In some embodiments, the reference direction may be determined based on a message from a first network node (e.g., a serving network node or Base Station).

In some embodiments, the directional transmissions and/or receptions may be towards/from at least one second network node e.g. intended for positioning purpose.

In some embodiments, the reference direction may be determined by the direction in which a specific signal is received from a third network node. In certain embodiments, the second network node and the third network node are the same network node.

In some embodiments, the reference direction may be one or more angles in degrees.

In some embodiments, the one or more preferred directions comprise a continuous or discrete set of one or more specific relative directions, angular interval or a range with respect to the reference direction. For example, the one or more preferred directions may be described by means of angular description or encoded based on pre-defined rules, with respect to the determined reference direction. Alternatively, the one or more preferred directions may be described in angular form with respect to x/y/z axes.

In some embodiments, the reference direction and/or the preferred direction may be associated with a positioning reference signal (PRS) identification (ID).

In some embodiments, the method may comprise: further obtaining one or more transmit and/or receive configuration parameters associated with one or more preferred directions with respect to the reference direction. For example, said transmit and/or receive configuration parameters may comprise any one or more of: antenna or precoder weights, antenna ports, transmit power or one or more power control or power back off related parameters, beam width, radio signal types to be received or transmitted via the preferred directions, radio signal density, periodicity, time-frequency allocation, subcarrier spacing (SCS), bandwidth, carrier frequency, number of signal instances in time, and parameters characterizing or used for generating the radio signal sequence to be transmitted/received in the preferred directions. In some embodiments, a first set of transmit and/or receive configuration parameters may be configured in a first set of preferred directions directed towards a radio network node with a reference direction and a second set of transmit and/or receive configuration parameters is configured in a second set of preferred directions or other directions not comprised in the first set.

In some embodiments, obtaining one or more preferred directions with respect to the reference direction may comprise adjusting or optimizing earlier obtained one or more preferred directions with respect to the reference direction.

In some embodiments, obtaining one or more preferred directions with respect to the reference direction is based on one or more of: wireless device radio measurements, feedback from a network node, reconfiguration or updating of the set of the preferred directions received from a network node, precoder weights received from a network node, and upon determining of a change of the reference direction.

In some embodiments, the method may further comprise: updating the preferred direction(s) upon a change of the determined reference direction.

In some embodiments, the method may comprise: performing one or more directional transmissions and/or receptions using beamforming based on the obtained preferred direction(s) with respect to the determined reference direction.

In some embodiments, the method may comprise: performing (503) one or more directional transmissions and/or receptions using beamforming further based on obtained transmit and/or receive configuration parameters associated with preferred direction(s).

In some embodiments, the method may further comprise: optimizing or reconfiguring the preferred direction(s) autonomously or based on a message from a network node.

According to yet another aspect, a wireless device is provided. The wireless device comprises: processing circuitry; and a memory; said memory comprising instructions executable by said processing circuitry whereby said wireless device is operative to perform the method according to the above-described aspect.

According to a further aspect, a computer program product is provided. The computer program product comprises instructions, which, when executed on at least one processor, cause the at least one processor to carry out the method according to the above-described aspect.

According to still another aspect, a method performed by a network node (e.g. for positioning purposes) is provided. The method comprises determining a reference direction for a wireless device; obtaining one or more preferred directions with respect to the reference direction; and performing one or more directional transmissions and/or receptions based on the obtained preferred direction(s) with respect to the determined reference direction.

In some embodiments, the reference direction may be determined based on a message from a first network node (e.g., a serving network node or Base Station).

In some embodiments, the directional transmissions and/or receptions may be towards/from at least one second network node e.g. intended for positioning purpose.

In some embodiments, the reference direction may be determined by the direction in which a specific signal is received from a third network node. In certain embodiments, the second network node and the third network node are the same network node.

In some embodiments, the reference direction may be one or more angles in degrees.

In some embodiments, the one or more preferred directions comprise a continuous or discrete set of one or more specific relative directions, angular interval or a range with respect to the reference direction.

In some embodiments, the one or more preferred directions may be described by means of angular description or encoded based on pre-defined rules, with respect to the determined reference direction. Alternatively, the one or more preferred directions may be described in angular form with respect to x/y/z axes.

In some embodiments, the reference direction and/or the preferred direction may be associated with a positioning reference signal (PRS) identification (ID).

In some embodiments, determining the reference direction for a wireless device may comprise: receiving the reference direction from said wireless device.

In some embodiments, determining the reference direction for a wireless device may comprise: receiving the reference direction from a network node serving said wireless device.

In some embodiments, the reference direction is received either upon a request.

In some embodiments, the method may comprise: configuring the reference direction for said wireless device via dedicated signaling, multicast or broadcast.

In some embodiments, the method may comprise: instructing said wireless device to use a specific reference direction.

In some embodiments, the method may comprise: obtaining one or more transmit and/or receive configuration parameters associated with one or more preferred directions with respect to the reference direction.

In some embodiments, said transmit and/or receive configuration parameters may comprise any one or more of: antenna or precoder weights, antenna ports, transmit power or one or more power control or power back off related parameters, beam width, radio signal types to be received or transmitted via the preferred directions (e.g., positioning signals), radio signal density, periodicity, time-frequency allocation, subcarrier spacing (SCS), bandwidth, carrier frequency, number of signal instances in time, and parameters characterizing or used for generating the radio signal sequence to be transmitted/received in the preferred directions.

In some embodiments, the method may comprise: optimizing or reconfiguring the current or earlier configured preferred direction(s).

In some embodiments, performing one or more directional transmissions and/or receptions based on the obtained preferred direction(s) with respect to the determined reference direction may comprise: configuring the one or more obtained preferred directions for one or more UE via dedicated signaling, multicast, or broadcast.

In some embodiments, performing one or more directional transmissions and/or receptions based on the obtained preferred direction(s) with respect to the determined reference direction comprises: signaling the preferred directions and/or reference directions to another network node.

According to yet another aspect, a network node is provided. The network node may comprise, processing circuitry; and a memory; said memory comprising instructions executable by said processing circuitry whereby said network node is operative to perform the method according to the above-described aspect.

According to a further aspect, a computer program product is provided. The computer program product comprises instructions, which, when executed on at least one processor, cause the at least one processor to carry out the method according to the above-described aspect.

Embodiments herein provide a network node that may control one or more preferred transmission and/or reception directions e.g. beam transmissions or receptions, for a UE with respect to a reference direction, e.g., for positioning (the continuous or discrete set of preferred directions comprises at least one direction different from the best SSB direction determined by the UE; the reference direction may be the best DL beam or SSB direction or the reference angle can be based upon for example azimuth angle, wherein the azimuth angle is measured with respect to the x-axis anti-clockwise; other reference angle such as zenith or elevation angle can be also considered or combined with azimuth angle). The network node may further configure one or more radio network nodes for receiving UE's radio signals transmitted in the configured preferred directions.

Optionally, the network node may also provide other parameters to control the beamforming, with preferred directions, based operation of the UE or its transmissions/receptions in the preferred directions such as precoder weights, power boosting level, etc. The UE would be required to use these configurations in order to be able to project the beam(s) in a network preferred way, at least for the corresponding purpose or application. This leads to an improved performance of the wireless communication network facilitating operation for directing transmissions/receptions of UEs.

### DETAILED DESCRIPTION

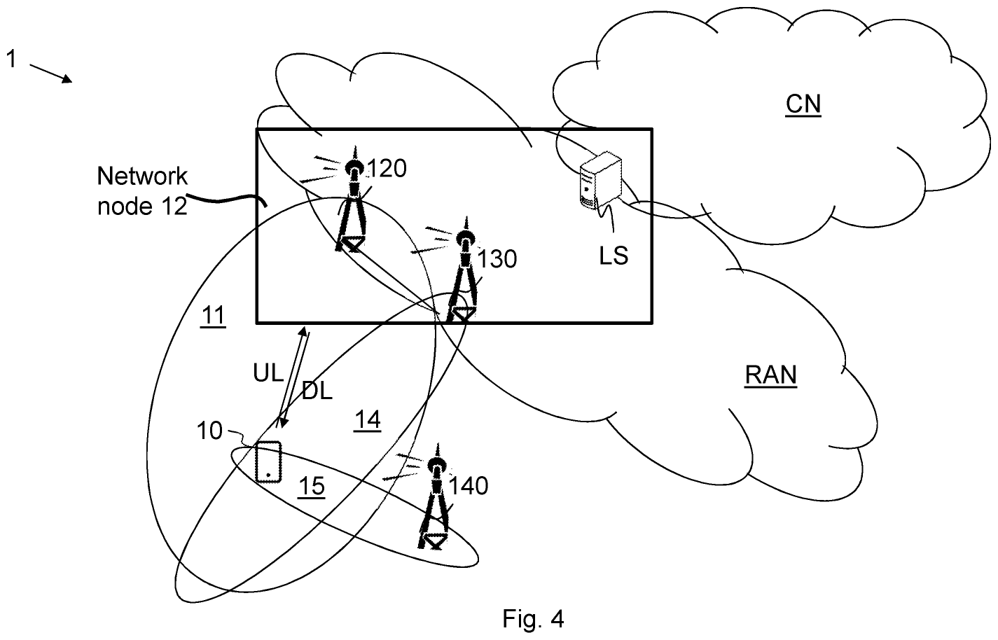

Embodiments herein relate to wireless communication networks in general. FIG. 4 is a schematic overview depicting a wireless communication network 1. The wireless communication network 1 comprises one or more RANs e.g. a first RAN (RAN1), connected to one or more CNs. The wireless communication network 1 may use one or more technologies, such as Long Term Evolution (LTE), LTE-Advanced, 5G, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are applicable also in further development of the existing communication systems such as e.g. 3G and LTE.

In the wireless communication network 1, wireless devices e.g. a UE 10 such as a mobile station, a non-access point (non-AP) station (STA), a STA, a UE and/or a wireless terminal, are connected via the one or more RANs, to the one or more CNs. It should be understood by those skilled in the art that “UE” is a non-limiting term which means any terminal, wireless communication terminal, communication equipment, Machine Type Communication (MTC) device, Device to Device (D2D) terminal, or user equipment e.g. smart phone, laptop, mobile phone, sensor, relay, mobile tablets or any device communicating within a cell or service area.

The wireless communication network 1 comprises a radio network node 120. The radio network node 12 is exemplified herein as a first radio network node or a first RAN node providing radio coverage over a geographical area, a first service area 11, of a first radio access technology (RAT), such as NR, LTE, UMTS, Wi-Fi or similar. The radio network node 12 may be a radio access network node such as radio network controller or an access point such as a wireless local area network (WLAN) access point or an Access Point Station (AP STA), an access controller, a base station, e.g. a radio base station such as a NodeB, a gNodeB, an evolved Node B (eNB, eNodeB), a base transceiver station, Access Point Base Station, base station router, a transmission arrangement of a radio base station, a stand-alone access point or any other network unit capable of serving a UE 10 within the service area served by the radio network node 12 depending e.g. on the radio access technology and terminology used and may be denoted as a primary radio network node. The radio network node 12 may alternatively be denoted as a serving radio network node providing a primary cell for the UE 10.

The wireless communication network 1 comprises a second radio network node 130. The second radio network node 13 is exemplified herein as a second RAN node providing radio coverage over a geographical area, a second service area 14, of a second RAT, such as NR, LTE, UMTS, W-Fi or similar. The second radio network node 13 may be a radio access network node such as radio network controller or an access point such as a wireless local area network (WLAN) access point or an Access Point Station (AP STA), an access controller, a base station, e.g. a radio base station such as a NodeB, a gNodeB, an evolved Node B (eNB, eNodeB), a base transceiver station, Access Point Base Station, base station router, a transmission arrangement of a radio base station, a stand-alone access point or any other network unit capable of serving a UE 10 within the service area served by the second radio network node 13 depending e.g. on the radio access technology and terminology used and may be denoted as a secondary radio network node. The radio network node 130 may alternatively be denoted as a serving radio network node providing a secondary cell, e.g. primary secondary cell, for the UE 10.

The wireless communication network 1 comprises a third radio network node 140. The third radio network node 140 is exemplified herein as a third RAN node providing radio coverage over a geographical area, a third service area 15, of a third RAT, such as NR, LTE, UMTS, Wi-Fi or similar. It should be noted that a service area may be denoted as cell, beam, beam group or similar to define an area of radio coverage. The first RAT may the same or different RAT as the second/third RAT.

The wireless communication network may further comprise another network node such as a location server, or a controlling network node, arranged in the wireless communication network.

Embodiments herein disclose a network node 12 e.g. the first radio network node 120, the second radio network node 130 or the location server configured to direct directional transmissions and/or receptions from the UE based on one or more preferred directions with respect to a reference direction. Thus, the network node may e.g. direct transmissions and/or receptions of the UE 10 towards the second and third radio network node to e.g. improve determining location of the UE 10. Embodiments herein provide one or more of the following advantages: Possibility for network node to control the angular range of multiple UE transmissions with respect to a reference direction; Possibility for the UE to adapt its transmissions to a specific angular range with respect to a reference direction; Possibility for network node to control the angular range of UE receive beams with respect to a reference direction; Possibility for the UE to adapt its receiver to a specific angular range with respect to a reference direction; and no need of the exact UL/DL Beam alignment or beam correspondence as this would be energy inefficient from NW perspective. The UE 10 can simply receive the commands and associated configuration from the network node 12 on how to project the beams.

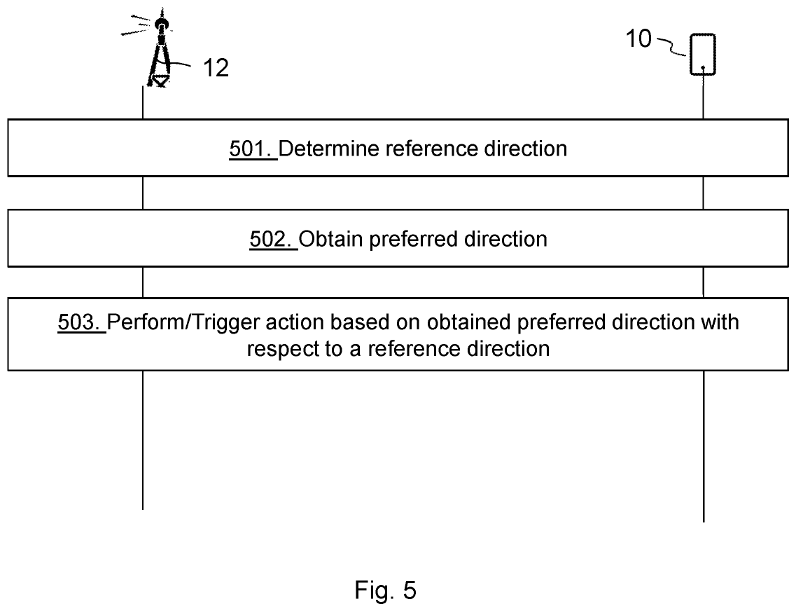

FIG. 5 is a schematic combined signaling scheme and flowchart depicting embodiments herein. The actions in FIG. 5 will initially be discussed from a UE perspective and then from a network node perspective.

Action 501. The UE 10 may determine a reference direction.
In some examples, the reference direction may be provided to the network node 12 (the network node 12 may further use it, e.g., to determine a set of preferred directions for the UE 10), e.g., as a best cell/beam index or the angular form; the reference direction may be provided in response to a request from the network node 12 or together with preferred directions request from the UE 10 and/or upon a change of the reference direction
In some examples, the UE 10 may monitor or keep track of the reference direction and update upon the need to do so

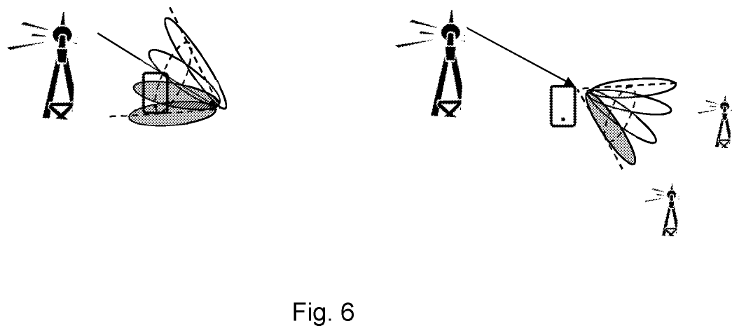

Action 502. The UE 10 may obtain one or more preferred directions with respect to the reference direction.
In some examples, the UE 10 may further obtain (based on a pre-defined rule or from a network node) one or more of transmit and/or receive configuration parameters associated with one or more preferred directions; the configurations may be the same or may be different for different preferred directions; the configuration parameters may comprise any one or more: antenna or precoder weights, antenna ports, transmit power or one or more power control or power back off related parameters, beam width, radio signal types to be received or transmitted via the preferred directions (e.g., positioning signals), radio signal density, periodicity, time-frequency allocation, subcarrier spacing (SCS), bandwidth, carrier frequency, number of signal instances in time, parameters characterizing or used for generating the radio signal sequence to be transmitted/received in the preferred directions, etc.
   In one example (see FIG. 6), a first set of transmit/receive configuration parameters can be configured in a first set of the preferred directions directed towards the radio network node with a reference direction and a second set of parameters can be configured in a second set of preferred directions or other directions not comprised in the first set
In some examples, the UE 10 may obtain the preferred direction(s) by adjusting or optimizing earlier obtained one or more preferred directions, e.g., based on one or more of: UE radio measurements (e.g., indicative of that the current preferred set of directions is suboptimal), feedback from a network node, reconfiguration or updating of the set of the preferred directions received from a network node, precoder weights received from a network node, or upon determining of a change of the reference direction (e.g., based on beam management or a message from a network node)
In some examples, the UE 10 may update the preferred directions upon a change of the reference direction.

Action 503. The UE 10 may perform one or more directional transmissions and/or receptions, e.g. using beamforming, based on the preferred directions with respect to a reference direction.

The UE may perform the one or more preferred directional transmissions and/or receptions further based on obtained one or more transmit or receive configurations associated with the preferred directions. The performing may further comprise one or more of:
configuring and performing transmissions in the preferred directions;
configuring and performing radio signal receptions in the preferred directions;
selecting one or more antennas or antenna ports for transmitting or receiving a radio signal, adaptively to the preferred directions;
adjusting UE transmitter filter and/or receiver filter;
adapting its beamforming configuration which may also comprise beam width, number of beams, etc. to cover the preferred directions;
adapting UE transmit and/or receive beam sweeping configuration (e.g., determining the number of directions to sweep over, which directions, number of sweeps, etc.) to cover the preferred directions, e.g., the UE beam sweep may be performed within the set of the preferred directions but not outside this set, at least for the corresponding application or purpose;
determining and using the scaling factor related to beam sweeping to determine the measurement period, e.g., the scaling factor may be smaller when the preferred directions are configuring if this results in a fewer beam sweeps than without configuring preferred directions;
performing one or more measurements based on radio signals received in the preferred directions;
adapting UE output power or power backoff or transmit power control to different preferred directions, e.g., a first output power or radio signal transmit power level applies in a first preferred direction and a second level applies in a second preferred direction;
prioritizing transmissions and/or receptions in the preferred directions;
not receiving, adjusting the receive filter accordingly, in the preferred directions, at least for the application or purpose associated with the preferred directions;
not transmitting, adjusting the transmit filter accordingly, in the preferred directions, at least for the application or purpose associated with the preferred directions;
using a first set of transmit and/or receive configuration parameters (see examples above) for a set of preferred configurations and using a set of configuration parameters for other directions or for a second set of preferred directions.

The UE may further optimize or reconfigure the set of preferred directions, autonomously or based on a message from the network node 12.

Reference direction: In one example, the reference direction may be the serving cell direction determined by means of beam management (e.g., see FIG. 6). For example, the reference direction may be determined based on signal strength value, e.g. highest signal strength value measured, e.g., the best downlink (DL) beam, best SSB, beam with a specific ID, SSB with a specific ID, positioning beam, etc.

In another example, the reference direction may be a vertical direction, e.g. perpendicular to the Earth's surface, towards or the opposite to the Earth. In another example, the reference direction may be a direction of south pole or north pole. The reference direction may be an angle based upon for example azimuth angle, wherein the azimuth angle is measured with respect to the x-axis anti-clockwise. Other reference angle such as zenith or elevation angle can be also considered or combined with azimuth angle.

In another example, the reference direction is the direction of a certain object known to the UE 10 and which can be determined by the UE 10, e.g. a base station, a building or similar.

In another example, the reference direction is the direction of receiving positioning signal from a serving cell.

The determining of the reference direction may be based on radio signal measurements, sensors, positioning techniques, global navigation satellite system (GNSS), pre-defined rules, etc.

The determining of the reference direction may further be based on a message or an indication from a network node 12, e.g., SSB with a certain index, etc. In another example, it may be predefined that the best DL beam or SSB direction is the reference direction.

The UE 10 may further store each or the latest reference direction for a certain amount of time or at least until the preferred directions are obtained based on the reference direction or at least until the preferred directions are being used by the UE 10.

Preferred directions: A UE can be configured with one or more preferred directions in a set of preferred directions. Furthermore, the UE 10 may be configured with one or more sets of preferred directions, each set is with respect own reference direction.

The preferred directions may comprise a continuous or discrete set of one or more specific relative directions, angular interval or a range with respect to the reference direction. Some examples: +/−60, +/−90, or +/−120 degrees with respect to the reference direction, the interval [90, 270] degrees with respect to the reference direction, the interval of [0, 180] degrees with respect to the reference direction in a horizontal surface, the interval of [0, 45] degrees with respect to the reference direction in a vertical surface, a list of directions comprising {30, 60, −30, −60} degrees with respect to a reference direction, etc.

The preferred directions configuration may further comprise granularity or step, e.g., granularity of 30 degrees within the +/−90 degrees range.

The preferred directions configuration may further comprise the number of steps within a preferred range, e.g., 2 steps (directions) within the range (0, 90] degrees, which in average means 45 and 90 degrees directions.

The preferred directions may be configured explicitly by means of angular description or encoded based on pre-defined rules, with respect to the reference direction.

The preferred directions may also be described in angular form with respect to x/y/z-axes, etc., even though they can be determined based on the reference direction.

The set of preferred directions may depend on a certain application or service or function, e.g. the preferred directions may be different for positioning, radio resource management (RRM), mobility, interference coordination.

The set of preferred directions may further depend on UE location and/or environment.

The set of preferred directions comprises at least one preferred direction which is not aligned or parallel with the orientation of the best DL beam or SSB direction determined by the UE or requires a different antenna configuration or beam steering.

The preferred transmit/receive directions would generally comprise a subset of supported by the UE transmit/receive directions.

The preferred directions may be obtained from the network node 12, e.g., in the assistance data or measurement configuration or radio signal transmission configuration. In another example, the preferred directions may be pre-defined and may also be associated with a specific service or application.

The UE 10 may store each or the latest set of preferred directions associated with the reference direction, e.g., for a certain amount of time.

The preferred directions may be configured to better control directional transmit and/or receive with respect to other network node, to assist the UE 10 in selecting directions and reduce the complexity/time/efforts for UE beam sweeping, to reduce interference in the preferred directions, to control the configuration of transmissions/receptions in the preferred directions, etc.

FIG. 6 shows two non-limiting examples where the solid line is the reference direction, e.g., best line of sight (LOS) link, dashed line is the relative range for transmit and/or receive directions (beams) at the UE specified to cover a (dashed) conus shape with respect to the reference direction. The UE is performing beam sweeping over the preferred directions (using 2 subarrays at a time in the left figure and using one beam at a time in the right figure). In the left figure, the UE 10 may be configured with a first set of transmit parameters (e.g., reduced transmit power) in the preferred directions and with a 30 second set in other directions. In the right figure, the preferred directions are configured to transmit and/or receive in the direction of two other network nodes, e.g. the second and the third radio network node.

According to embodiments herein referring back to FIG. 5, the network node 12, e.g., a base station, location server, controlling network node, etc., may perform the following:
In some embodiments the network node 12 may obtain a reference direction, action 501, for one or more UEs.
   In one example, the network node 12 may receive a reference direction from the UE 10 or its serving base station, e.g., upon a request or in an unsolicited way.
In some embodiments the network node 12 may configure the reference direction, action 501, for one or more UE via dedicated signaling, multicast, or broadcast.
   Here, the network node 12 may instruct the UE 10 to use a specific reference direction for one or more preferred directions.
In some embodiments the network node 12 may obtain one or more preferred directions, action 502, with respect to the obtained or determined reference direction.
   The obtained preferred directions may further comprise one or more of transmit and/or receive signal configurations associated with one or more preferred directions; the configurations may be the same or may be different for different preferred directions; the configuration(s) may comprise any one or more: antenna or precoder weights, transmit power or one or more power control related parameters, beam width, radio signal types to be received or transmitted via the preferred directions (e.g., positioning signals), radio signal density, periodicity, time-frequency allocation, SCS, bandwidth, carrier frequency, number of signal instances in time, parameters characterizing or used for generating the radio signal sequence, etc.
   In some embodiments the network node 12 may obtain by optimizing or reconfiguring the current or earlier configured preferred directions, e.g., based on the results of the UE 10 using the preferred directions such as UE measurement results or network measurements based on UE transmissions in the preferred directions
In some embodiments the network node 12 may perform, action 503, or trigger action being at least one of:
   configuring the one or more obtained preferred directions for one or more UE via dedicated signaling, multicast, or broadcast;
   signaling to another network node, e.g. the first radio network node 120 or the second radio network node 130, the preferred directions and/or reference directions;
   determining a set of one or more of radio network nodes to receive and/or measure on the UE's radio signals transmitted in the preferred directions, e.g. a first set may be determined for a first set of preferred directions and a second set may be determined for a second set of preferred directions for the same UE; these radio network nodes may further be provided with the UE's radio signals configuration to be received by the radio network nodes;
   configuring assistance data based on the set of obtained preferred directions and providing the assistance data to the UE and/or another measuring node receiving radio signals from the UE transmitting in the preferred directions; the assistance data may comprise one or more of: preferred directions, UE actions or transmit and/or receive configurations associated with the preferred directions, transmit power related parameters associated with the preferred directions, search window configuration based on the preferred directions.
In some embodiments the network node 12 may obtain one or more results of the UE 10 performing one or more preferred directional transmissions and/or receptions with respect to the reference direction, e.g., receiving UE measurements from the UE 10 or performing measurements based on UE transmissions in the preferred directions
In some embodiments, the network node 12 may use the obtained result for one or more operational tasks, e.g., RRM, positioning (position calculation), location-aware or location-based services, interference coordination, minimization of drive test (MDT), providing feedback to the UE regarding the current preferred directions, etc.

As will be appreciated, the steps or actions above can be in a different order.

The network node 12 may obtain the reference direction and/or preferred directions based on, e.g., pre-defined rules, implicit or explicit reference direction indication from the UE, measurement report from the UE or its serving base station, best beam(s) report from the UE or serving base station, message from another node (e.g., O&M, SON, MDT, location server, base station).

The network node 12 may provide feedback to the UE 10 on the current set of preferred directions, based on which the UE can update the set of the preferred directions; the feedback may comprise, e.g., precoder weights, UL measurement results for the current preferred directions or correction factors which UE can use to optimize the preferred directions or radio signal transmission and/or reception configuration to be applied at the UE to optimize the performance with the current set of preferred directions. In some examples, the network node may also provide other parameters that would influence the beamforming (with preferred directions) based operation of the UE such as precoder weights, power boosting level, etc. The UE would be required to use these configuration in order to be able to project the beam(s) in network preferred way, at least for the corresponding purpose or application.

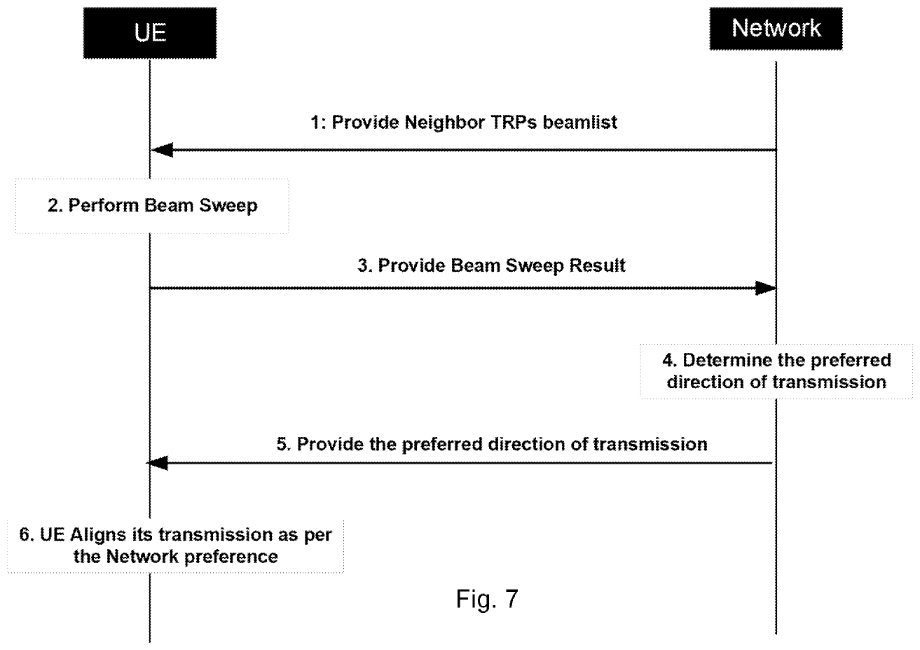

FIG. 7 illustrates an example flow between a UE and a network node for a scenario when preferred directions are UE UL transmission directions. In this figure, the UE may perform measurements based on radio signals (e.g., SSBs or positioning signals which may be associated with beams) received from different directions transmitted by the configured neighbor TRPs (TRP=transmission/reception point). UE measurement results may be provided to a network node which can be used for obtaining/determining of the preferred directions of UE transmissions. The preferred directions may be configured with respect to the best SSBs. FIG. 7 is a basic signalling flow between the UE and the network node for the preferred UL transmission directions.

The network node may provide 701 a list of beams for neighbour TRPs to the UE 10.

The UE may then perform 702 a beam sweep as configured.

The UE may further provide 703 a result of the beam sweep back to the network node.

The network node may then determine 704 preferred direction of transmission based on the received result.

The network node may further provide 705 an indication of the preferred direction to the UE.

The UE receives 706 the indication and may align its transmission as per the preferred direction.

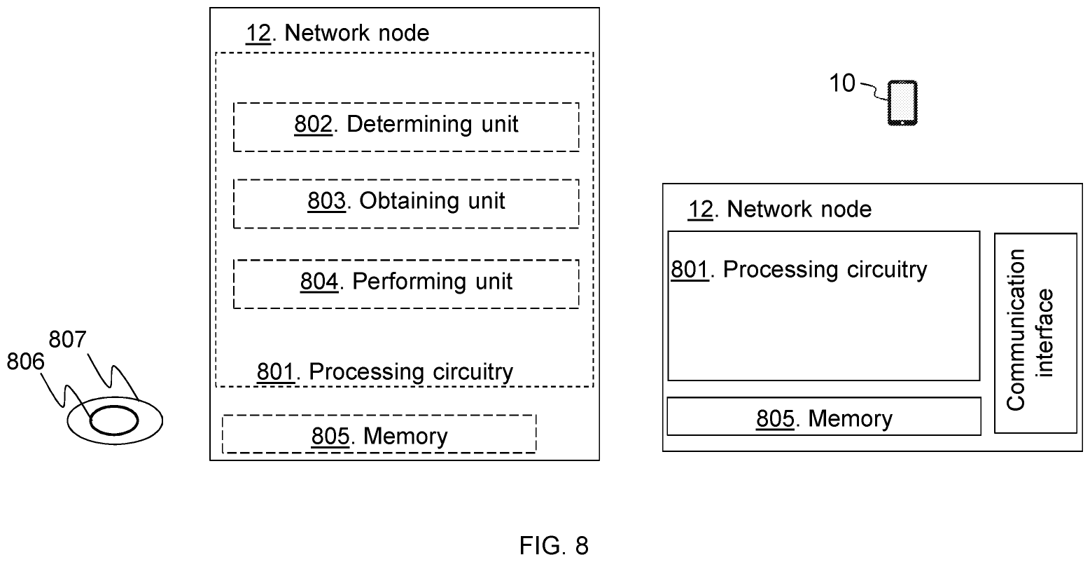

FIG. 8 is a block diagram depicting the network node 12, e.g. the first or the second radio network node or location server, for handling communication such as transmission/reception of the UE 10 in the wireless communication network according to embodiments herein.

The network node 12 such as a radio base station may comprise processing circuitry 801, e.g. one or more processors, configured to perform the methods herein.

The network node 12 may comprise a determining unit 802. The network node 12, the processing circuitry 801 and/or the determining unit 802 is configured to determine the reference direction.

The network node 12 may comprise an obtaining unit 803, e.g. a receiver or transceiver. The network node 12, the processing circuitry 801 and/or the obtaining unit 803 is configured to obtain one or more preferred directions with respect to the reference direction.

The network node 12 may comprise a performing unit 804, e.g. a transmitter or transceiver. The network node 12, the processing circuitry 801 and/or the performing unit 804 is configured to perform one or more operations for one or more directional transmissions and/or receptions based on the preferred directions with respect to the reference direction.

The network node 12 further comprises a memory 805. The memory comprises one or more units to be used to store data on, such as indications, directions, performance, weights, precoder, applications to perform the methods disclosed herein when being executed, and similar. Thus, the network node 12 may comprise the processing circuitry and the memory, said memory comprising instructions executable by said processing circuitry whereby said radio network node is operative to perform the methods herein.

The methods according to the embodiments described herein for the network node 12 are respectively implemented by means of e.g. a computer program product 806 or a computer program, comprising instructions, i.e., software code portions, which, when executed on at least one processor, cause the at least one processor to carry out the actions described herein, as performed by the radio network node. The computer program product 806 may be stored on a computer-readable storage medium 807, e.g. a disc, a universal serial bus (USB) stick, or similar. The computer-readable storage medium 807, having stored thereon the computer program product 806, may comprise the instructions which, when executed on at least one processor, cause the at least one processor to carry out the actions described herein, as performed by the network node. In some embodiments, the computer-readable storage medium may be a non-transitory computer-readable storage medium.

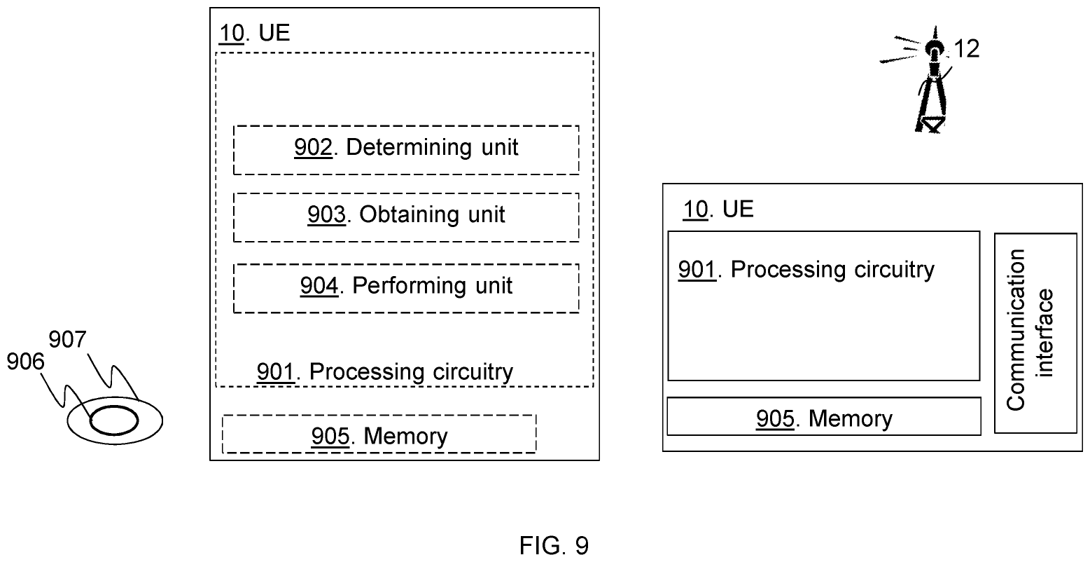

FIG. 9 is a block diagram depicting the UE 10 for handling access to one or more radio network nodes in the wireless communication network according to embodiments herein.

The UE 10 may comprise processing circuitry 901, e.g. one or more processors, configured to perform the methods herein.

The UE 10 may comprise a determining unit 902. The UE 10, the processing circuitry 901 and/or the determining unit 902 is configured to determine the reference direction.

The UE 10 may comprise an obtaining unit 903, e.g. a receiver or transceiver. The UE 10, the processing circuitry 901 and/or the obtaining unit 903 is configured to obtain one or more preferred directions with respect to the reference direction.

The UE 10 may comprise a performing unit 904, e.g. a transmitter or transceiver. The UE 10, the processing circuitry 901 and/or the performing unit 904 is configured to perform one or more directional transmissions and/or receptions based on the preferred directions with respect to a reference direction.

The UE 10 further comprises a memory 905. The memory comprises one or more units to be used to store data on, such as indications, directions, weights, antenna data, cells, applications to perform the methods disclosed herein when being executed, and similar. Thus, the UE 10 may comprise the processing circuitry and the memory, said memory comprising instructions executable by said processing circuitry whereby said wireless device 10 is operative to perform the methods herein. The UE may comprise a communication interface comprising e.g. a transmitter, a receiver, a transceiver and/or one or more antennas.

The methods according to the embodiments described herein for the UE 10 are respectively implemented by means of e.g. a computer program 906 or a computer program product 1105, comprising instructions, i.e., software code portions, which, when executed on at least one processor, cause the at least one processor to carry out the actions described herein, as performed by the UE 10. The computer program product 906 may be stored on a computer-readable storage medium 907, e.g. a disc, USB stick or similar. The computer-readable storage medium 907, having stored thereon the computer program product 906, may comprise the instructions which, when executed on at least one processor, cause the at least one processor to carry out the actions described herein, as performed by the UE 10. In some embodiments, the computer-readable storage medium may be a non-transitory computer-readable storage medium.

Herein, the term “positioning measurement” may comprise e.g. any of: timing-based positioning measurement, time difference of arrival (TDOA), time of arrival (TOA), reference signal time difference (RSTD), observed time difference of arrival (OTDOA) measurement, UE Rx-Tx measurement involving measuring a signal from a neighbor cell, etc.

Herein, the term “reference link” may comprise e.g. one or more of: serving cell, reference cell (in some examples, may be different from the serving cell), serving beam, best beam, reference beam (in some examples, may be different from the serving or best beam), reference carrier frequency and/or frequency range (e.g., FR1 and FR2), reference bandwidth part, etc. The reference link may also potentially be one of the two links to be used for the positioning measurement, e.g., TDOA will be measurement between the reference link and another link. The reference link may also be the one with respect to which or based on which the search window is to be determined.

Herein, the term “search window configuration” may comprise, e.g., one or more parameters related to: expected measurement value, amount of the expected measurement uncertainty, absolute or relative expected center of the search window, absolute or relative start time of search window, size of the search window (e.g., in Tc units wherein Tc is defined in TS 38.211), size of the half of the search window (e.g., in Tc units), expected RSTD, expected RSTD uncertainty, measurement report mapping table for beam-based RSTD measurements, measurement reporting resolution, and/or the corresponding RSTD range (e.g., minimum and maximum RSTD), etc. So, a “first search window configuration” and a “second search window configuration”, unless explicitly stated, can have at least one value of the above parameters different, wherein the values are determined adaptively to corresponding beamforming configurations. For example, different resolution/step size and/or different RSTD measurement report mapping may be used to define the first search window size and the second search window size or the expected RSTD of the first search window configuration and the expected RSTD of the second search window configuration.

Herein, the term “positioning signal” may comprise, e.g., any signal or channel to be received by the UE for performing a positioning measurement such as a DL reference signal, positioning reference signal (PRS), Synchronization Signal Block (SSB), synchronization signal, demodulation reference-signal (DM-RS), channel state information—reference signal (CSI-RS), etc. In one example, positioning signal may be configured with a sequence based on signal ID, e.g., PRS ID, resource set, resource within the resource set, periodicity (or can be aperiodic too).

Herein, the term “beamforming” may comprise any of: possibility to transmit and/or receive radio signal in different directions without moving the antenna physically, a cell consisting of or comprising multiple beams, transmitting two or more SSBs in a single cell from the same location, using analog, hybrid or digital beamforming in the transmitting and/or receiving node, possibility of directionally transmitting and/or receiving different signals in two or more different directions at the same location, transmitting signals from different transmitter branches (comprising one or more antenna elements), directional transmissions in a mmwave frequency range or FR2 or above 6 GHz. A UE may determine and/or report the number of detected beams, per cell or per carrier. There may also be UE measurement capability in terms the maximum number of beams the UE is expected to be able to handle at the same time. In some cases, a beam may be associated with a port ID or signal Id such as SSB ID (on a carrier where SSBs are present) or other signal ID such as DM-RS ID or CSI-RS ID (e.g., on carriers where SSBs are not transmitted but other signals are used to differentiate beams). Furthermore, a signal may be associated with a beam via a TCI configuration or co-location or quasi-colocation (QCL) property with respect to another signal, channel, or CORESET directionally transmitted via a beam, e.g., co-located or quasi-collocated with the corresponding SSB and/or CSI-RS.

Herein, the terms “beamforming configuration” and “beam configuration” may be interchangeably used.

The term “base station” is generically used to denote a network node or transmitting point transmitting radio signals. It can be a base station, gNB, transmission and reception point (TRP), transmission point (TP), a transmitter with a distributed antenna system, remote radio head (RRH), positioning beacon, another UE or device transmitting radio signals to be used for positioning by other UEs, a etc. The base station may communicate with other network nodes, e.g., another base station, location server, etc.

The term “location server” is used herein to denote a network node with positioning functionality, e.g., ability to provide assistance data and/or request positioning measurements and/or calculate a location based on positioning measurements. Location server may or may not reside in a base station.

The term “preferred direction” is used to denote a directional (beamforming based) transmission or receiving of a radio signal at the UE. A preferred direction configuration may comprise, e.g., beam configuration and/or relative angular configuration with respect to a reference direction.

The term “elevation angle” is used herein to denote the angle between the Z axis and the ray (Propagation Channel). Elevation is set between 0° and 180°. The azimuth is defined as being the angle between the X-axis (or between the x0y plane) and the perpendicular projection of the ray. The azimuth may vary in a range of up to 360°; zenith angle=90°−elevation.

The term a network node configuring UE or transmitting to UE may comprise e.g. transmitting via higher-layer signaling or physical-layer signaling, e.g., any one or more of (also depending on the type of network node): physical downlink control channel (PDCCH), downlink control information (DCI), radio resource control (RRC), medium access control (MAC), LTE positioning protocol (LPP), NR positioning protocol (NRPP), System Information, NRPPa+RRC, LPPa+RRC, etc. Note also that communication with e.g. location server may be via a radio network node such as LPP goes via serving base station or the combination of NRPPa and RRC may also be used in this case.

The term a network node configuring UE or transmitting to UE may comprise e.g. transmitting via higher-layer signaling or physical-layer signaling, e.g., any one or more of (also depending on the type of network node): PDCCH, DCI, RRC, MAC, LPP, NRPP, System Information, NRPPa+RRC, LPPa+RRC, etc. Note also that communication with e.g. location server may be via a radio network node such as LPP goes via serving base station or the combination of NRPPa and RRC may also be used in this example.

The term a UE indicating/transmitting to a network node may comprise e.g. transmitting via higher-layer signaling or physical-layer signaling, e.g., any one or more of (also depending on the type of network node): physical uplink control channel (PUCCH), RRC, LPP, NRPP, NRPPa+RRC, LPPa+RRC, etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a radio network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of radio network nodes will appreciate the cost, performance, and maintenance trade-offs inherent in these design choices.

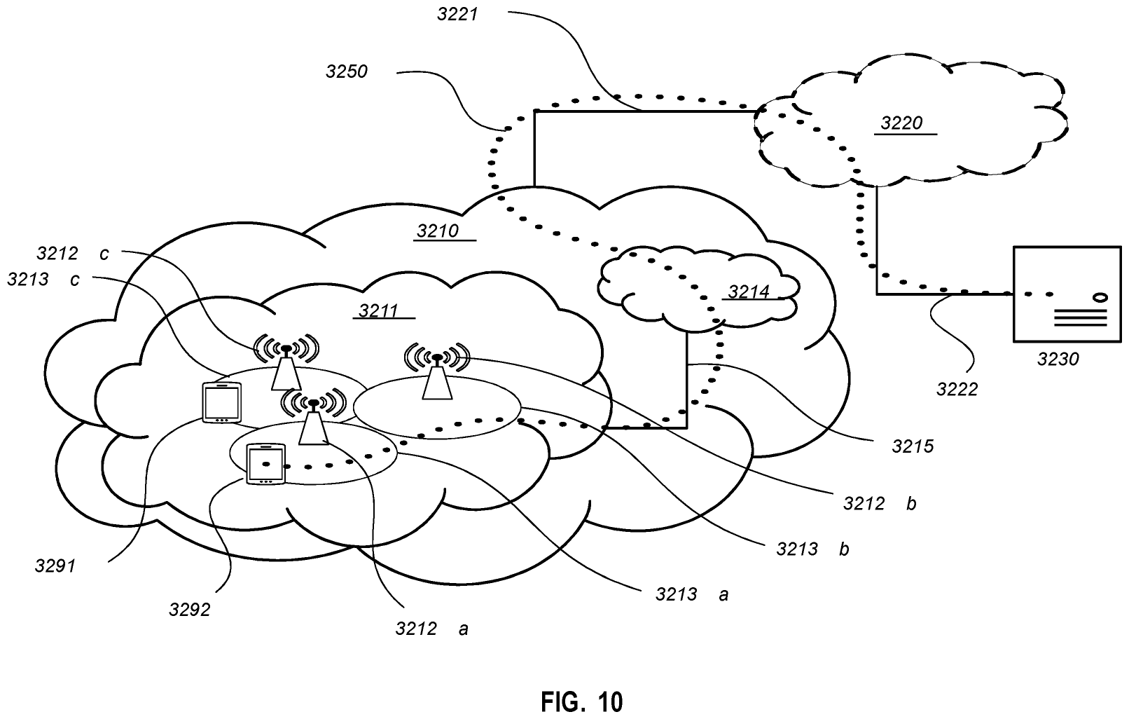

With reference to FIG. 10, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network nodes herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the wireless device 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

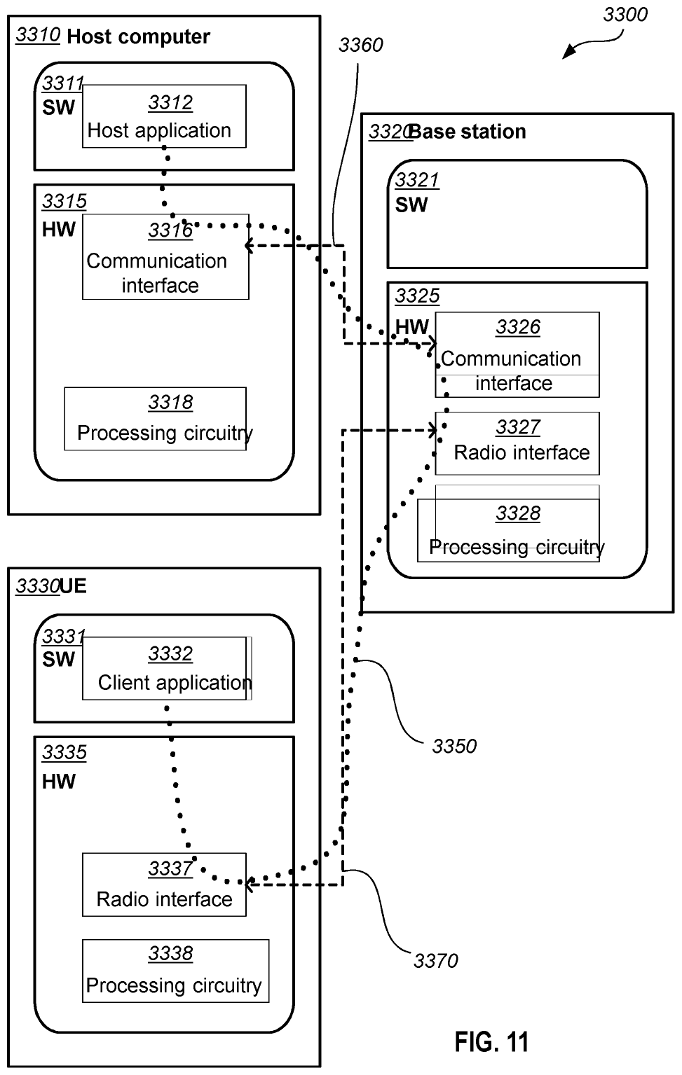

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve accuracy of services since the TX/RX may be directed as requested and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

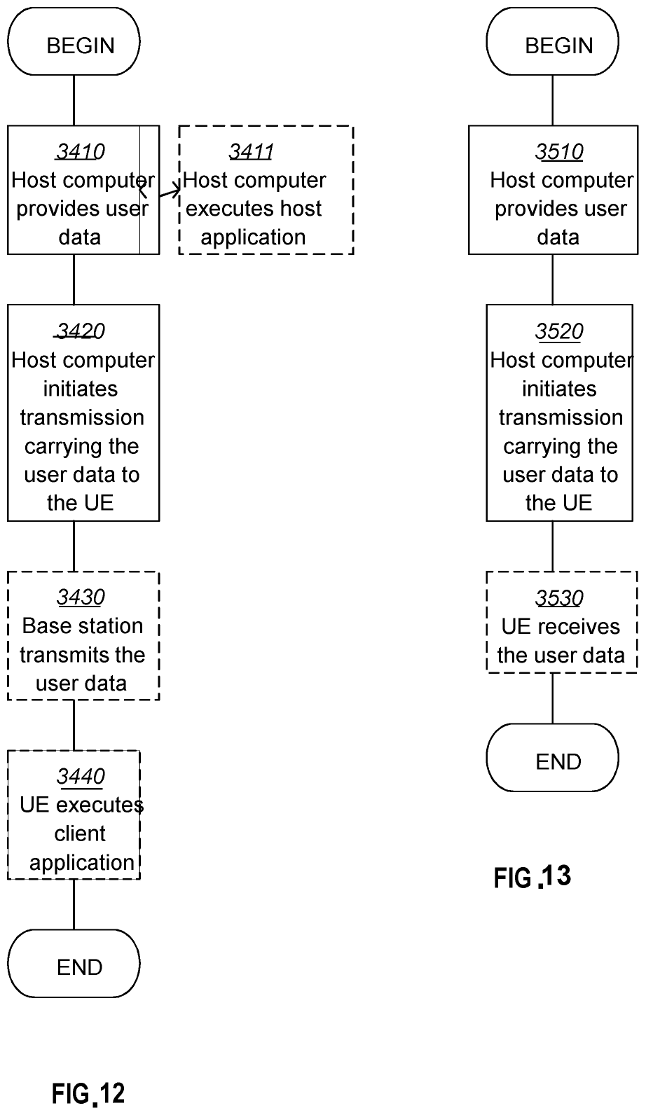

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

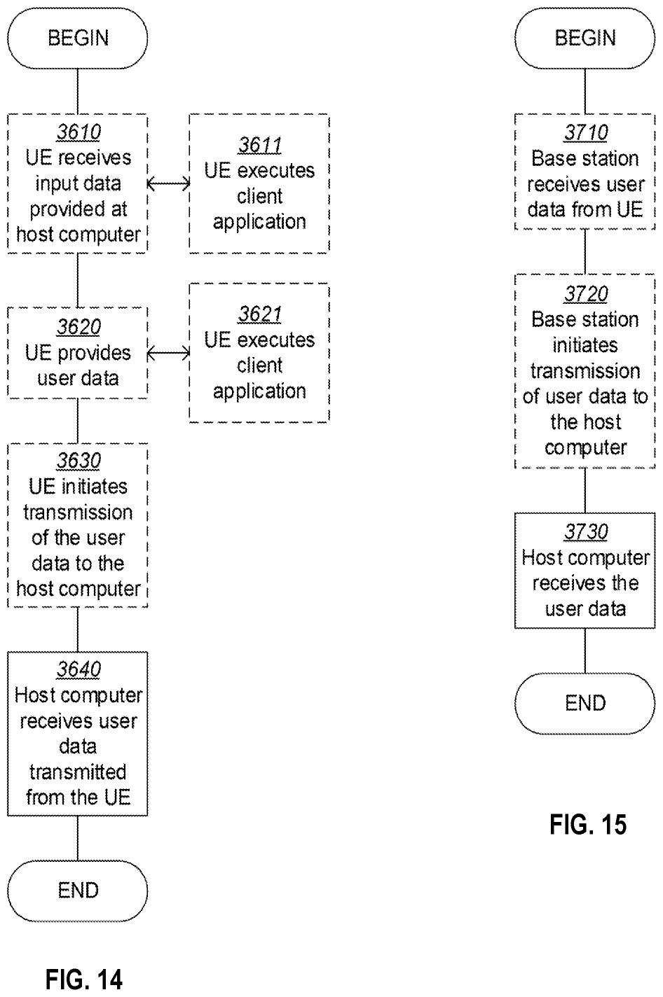

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 3610 of the method, the UE receives input data provided by the host computer. Additionally, or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method performed by a wireless device, comprising:
determining a reference direction;
obtaining one or more preferred directions with respect to the reference direction; and
performing one or more directional transmissions and/or receptions based on the obtained preferred direction(s) with respect to the determined reference direction.

2. The method according to claim 1, wherein the one or more preferred directions comprise a continuous or discrete set of one or more specific relative directions, angular interval or a range with respect to the reference direction.

3. The method according to claim 2, wherein the one or more preferred directions is described by means of angular description or encoded based on pre-defined rules, with respect to the determined reference direction.

4. The method according to claim 2, wherein the one or more preferred directions is described in angular form with respect to x/y/z axes.

5. The method according to claim 1, comprising: further obtaining one or more transmit and/or receive configuration parameters associated with one or more preferred directions with respect to the reference direction.

6. The method according to claim 5, wherein said transmit and/or receive configuration parameters comprise any one or more of: antenna or precoder weights, antenna ports, transmit power or one or more power control or power back off related parameters, beam width, radio signal types to be received or transmitted via the preferred directions, radio signal density, periodicity, time-frequency allocation, subcarrier spacing, bandwidth, carrier frequency, number of signal instances in time, and parameters characterizing or used for generating the radio signal sequence to be transmitted/received in the preferred directions.

7. The method according to claim 5, wherein a first set of transmit and/or receive configuration parameters is configured in a first set of preferred directions directed towards a radio network node with a reference direction and a second set of transmit and/or receive configuration parameters is configured in a second set of preferred directions or other directions not comprised in the first set.

8. The method according to claim 1, wherein obtaining one or more preferred directions with respect to the reference direction comprises adjusting or optimizing earlier obtained one or more preferred directions with respect to the reference direction.

9. The method according to claim 8, wherein obtaining one or more preferred directions with respect to the reference direction is based on one or more of: wireless device radio measurements, feedback from a network node, reconfiguration or updating of the set of the preferred directions received from a network node, precoder weights received from a network node, and upon determining of a change of the reference direction.

10. The method according to claim 1, further comprising:
updating the preferred direction(s) upon a change of the determined reference direction.

11. The method according to claim 1, comprising:
performing one or more directional transmissions and/or receptions using beamforming based on the obtained preferred direction(s) with respect to the determined reference direction.

12. The method according to claim 11, comprising:
performing one or more directional transmissions and/or receptions using beamforming further based on obtained transmit and/or receive configuration parameters associated with preferred direction(s).

13. The method according to claim 1, further comprising:
optimizing or reconfiguring the preferred direction(s) autonomously or based on a message from a network node.

14. A method performed by a network node, comprising:
determining a reference direction for a wireless device;
obtaining one or more preferred directions with respect to the reference direction; and
performing one or more directional transmissions and/or receptions based on the obtained preferred direction(s) with respect to the determined reference direction.

15. The method according to claim 14, wherein the one or more preferred directions comprise a continuous or discrete set of one or more specific relative directions, angular interval or a range with respect to the reference direction.

16-27. (canceled)

28. A wireless device, comprising:
processing circuitry; and
a memory; said memory comprising instructions executable by said processing circuitry whereby said wireless device is operative to perform the method according to claim 1.

29. A network node, comprising:
processing circuitry; and
a memory; said memory comprising instructions executable by said processing circuitry whereby said network node is operative to perform the method according to claim 14.

30. (canceled)
